(19) United States
(12) Patent Application Publication
(10) Pub. No.: US 2009/0302819 A1
(43) Pub. Date: Dec. 10, 2009

(54) Circuit for Preventing Reverse Current and Method thereof

(76) Inventor: Ching-Tsan Lee, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/324,892

(22) Filed: Nov. 28, 2008

(30) Foreign Application Priority Data
Jun. 9, 2008 (TW) 097121397

(51) Int. Cl. G05F 1/00

(52) U.S. Cl. 323/284

(57) ABSTRACT

A circuit for preventing a reverse current is applicable to a voltage converter including a high-side switch, a low-side switch, and an inductor. The high-side and low-side switches are coupled in series between two power lines. The inductor is coupled between an output terminal of the voltage converter and a connection node connecting the high-side and low-side switches. The reverse current flows from the output terminal of the voltage converter to the connection node. The circuit includes a first detection module and a threshold voltage adjusting module. The first detection module detects whether the reverse current occurs within a dead time when both the high-side and low-side switches are off. The voltage adjusting module adjusts a crossing voltage according to whether the reverse current is detected. The low-side switch is turned off when the voltage of the connection node exceeds the crossing voltage.

### BACKGROUND OF THE INVENTION

1. Field of the Invention

The present invention relates to a circuit and related method for preventing a reverse current, and more particularly, to a circuit and related method applied in a synchronous voltage converter for preventing a reverse current.

2. Description of the Prior Art

Please refer to FIG. 1, a circuit diagram of a conventional synchronous voltage converter 10. As illustrated in FIG. 1, synchronous voltage converter 10 converts the potential of the input voltage source Vᵢₙ to the potential of the output voltage Vₒᵤₜ. High-side switch SH, implemented with a p-type Metal-Oxide-Semiconductor Field-Effect Transistor (MOSFET), is coupled in between input voltage source Vᵢₙ and connection node SN. Low-side switch SL, implemented with an n-type MOSFET, is coupled in between connection node SN and ground. Inductor L is coupled in between connection node SN and output terminal Q. Control circuit 11 is utilized to generate and transmit control signal CS to driving circuit 12. Driving circuit 12 generates driving signals PH and PL according to control signal CS, for respectively controlling high-side switch SH and low-side switch SL to be turned on or off.

Please refer to FIG. 2, a timing diagram of an operation waveform of the synchronous voltage converter 10 in FIG. 1. As shown by FIGS. 1 and 2, driving circuit 12 generates both the driving signals PH and PL at substantially the same time according to the control signal CS. In the interval between time T1 and time T2, high-side switch SH is turned on, and low-side switch SL is turned off. During this interval, an inductive current I_{L} flows from the connection node SN to the output terminal Q in accordance, where the inductive current I_{L} is defined as being a positive current according to the abovementioned flowing direction, and moreover, the magnitude of the inductive current I_{L} continuously increases as time goes as well. In the interval between time T2 and time T4, driving signals PH and PL are both at a high potential so that high-side switch SH is turned off, and low-side switch SL is turned on; thereby the magnitude of the inductive current I_{L} continuously decreases as time goes. Please note that the magnitude of the inductive current I_{L} has been decreased to 0 at a time T3, and, therefore, in the interval between times T3 and T4, inductive current I_{L} flows from output terminal Q to connection node SN, and is hence defined as being a reverse current according to the current direction.

Referring FIG. 2, the areas with oblique lines indicate the occurrences of a reverse current. When inductive current I_{L} is reverse, the conversion efficiency of synchronous voltage converter 10 is reduced.

Synchronous voltage converter 30 shown in FIG. 3 is known in the art, and is used for solving the problem of the reverse current shown in FIG. 2. A positive input terminal of comparator 330 is coupled to connection node SN for detecting a voltage V_{SN} at connection node SN. The negative input terminal of comparator 330 is coupled to a voltage source 332, where an ideal value of the voltage source 332 is 0 volt. After low-side switch SL is turned on, as shown by FIG. 2, voltage V_{SN} at connection node SN increases gradually from a negative value. When this gradually-increased voltage V_{SN} reaches 0 volt, the reverse current is about to occur. At this moment, the logic level of the output signal of comparator 330 transits to force low-side switch SL to be off, trying to prevent the reverse current from occurring. The voltage value at the negative input terminal of comparator 330 could be regarded as a crossing voltage of a switching-type voltage converter for comparator 330 differentiating whether inductive current I_{L} is about to be reverse.

In practice, due to the delay for signals to propagate from of the comparator 330 to low-side switch SL, the crossing voltage is conventionally set to a negative value so as to earlier trigger an operation of turning off low-side switch SL. However, an over-negative crossing voltage would cause low-side switch SL to be turned off early, adversely suffering the conversion efficiency of the voltage converter in accordance. Moreover, a not-negative-enough crossing voltage would cause the occurrence of the reverse current because switch SL is turned off late.

### SUMMARY OF THE INVENTION

According to an embodiment of the present invention, a circuit for preventing a reverse current is disclosed. The disclosed circuit is applicable to a voltage converter, which includes a first switch, a second switch, and an inductor. The first switch and the second switch are coupled in series between two power lines. The inductor is coupled between an output terminal of the voltage converter and a connection node, which connects the first switch and the second switch. The reverse current flows from the output terminal of the voltage converter to the connection node. The disclosed circuit comprises a first detection module and a threshold voltage adjusting module. The first detection module is used for detecting whether a reverse current occurs within a dead time when the first and second switches are both off. The threshold voltage adjusting module is used for adjusting a crossing voltage according to the detection of the reverse current. The second switch is turned off when the voltage of the connection node exceeds the crossing voltage.

According to an embodiment of the present invention, a method for preventing a reverse current is disclosed. The disclosed method is applicable to a voltage converter, which includes a high-side switch, a low-side switch, and an inductor. The high-side switch and the low-side switch are coupled in series between a relatively-high power line and a relatively-low power line. The inductor is coupled between an output terminal of the voltage converter and a connection node, which connects between the high-side switch and the low-side switch. The reverse current flows from the output terminal of the voltage converter to the connection node. The disclosed method comprises detecting if a reverse current occurs during a dead time when the high-side and low-side switches are both off; and shortening a subsequent turned-on duration of the low-side switch when the reverse current is detected.

According to an embodiment of the present invention, a method for adjusting a crossing voltage to prevent the occurrence of a reverse current is further disclosed. The disclosed method is applicable to a voltage converter, which includes a high-side switch, a low-side switch, and an inductor. The high-side switch and the low-side switch are coupled to the inductor through a connection node. The reverse current flows from the inductor to the connection node. The disclosed method comprises turning off the low-side switch when the voltage of the connection node exceeds the crossing voltage; detecting the voltage of the connection node to determine if the reverse current occurs during a dead time when both the low-side and high-side switches are off; and decreasing the crossing voltage when the reverse current is detected during the dead time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a synchronous voltage converter in the prior art.

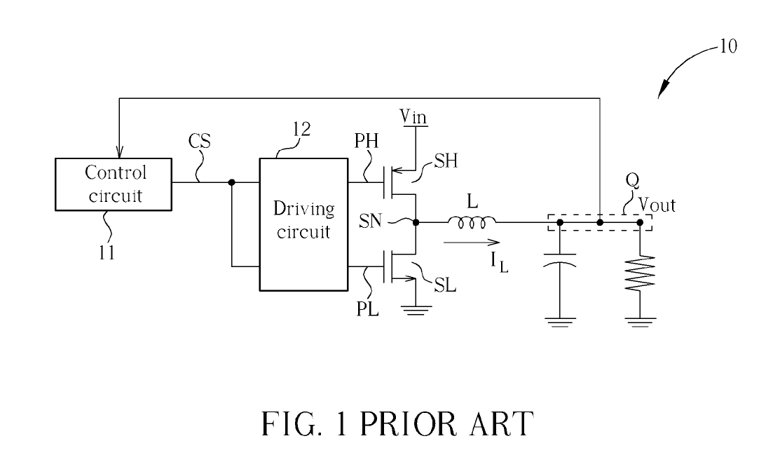

FIG. 2 is a timing diagram of the operation waveform of the synchronous voltage converter in FIG. 1.

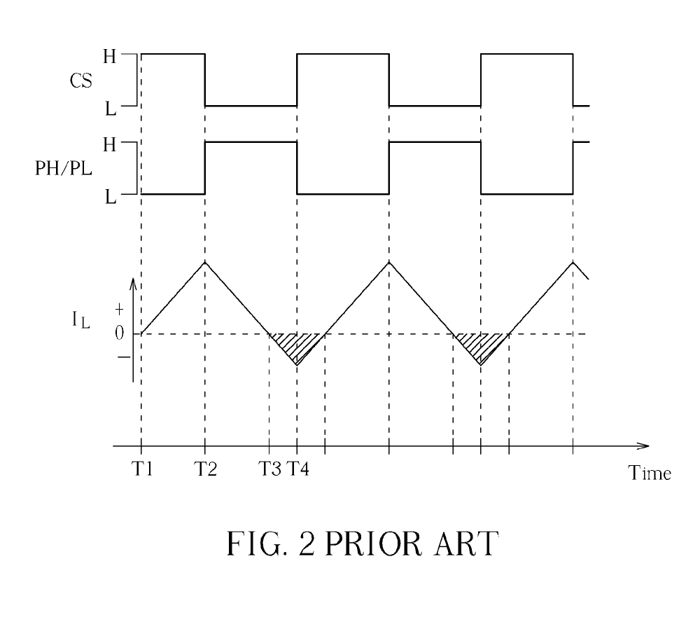

FIG. 3 is a circuit diagram illustrating a synchronous voltage converter in the prior art for reducing the reverse current.

FIG. 4 is a waveform diagram of relevant signals when a reverse current occurs.

FIG. 5 is a waveform diagram of relevant signals when a residual positive current occurs.

FIG. 6 is a circuit diagram of one of the circuits for preventing a reverse current of the present invention.

### DETAILED DESCRIPTION

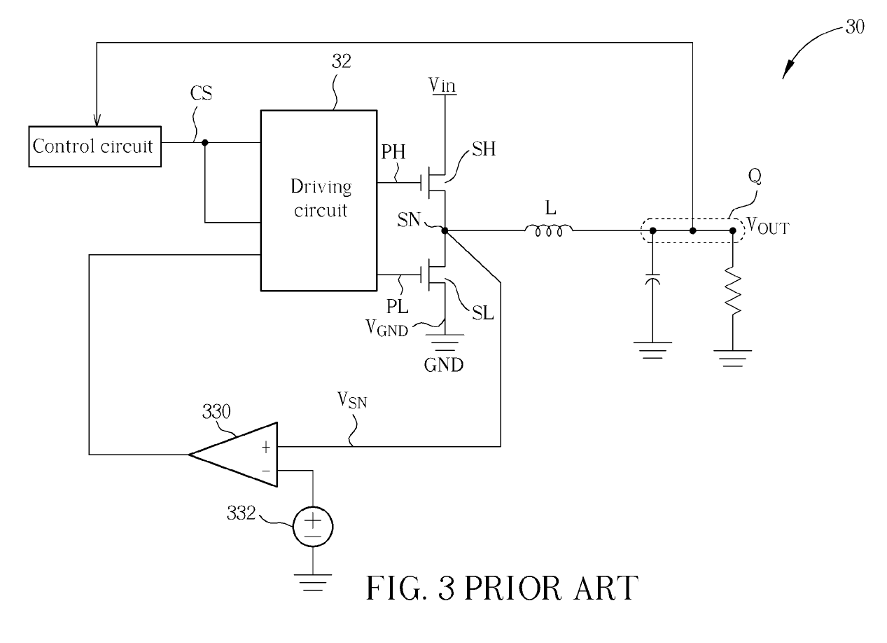

An embodiment of the present invention takes advantages of the synchronous voltage converter 30 in FIG. 3. Nevertheless, every time before a high-side or low-side switch is turned on, a dead time is defined or reserved to turn off both high-side switch SH and low-side switch SL. Thus, at anytime during operation, either high-side switch SH or low-side switch SL is assured to be off, avoiding the formation of a current path from power line V_{IN} to power line GND via high-side switch SH and low-side switch SL.

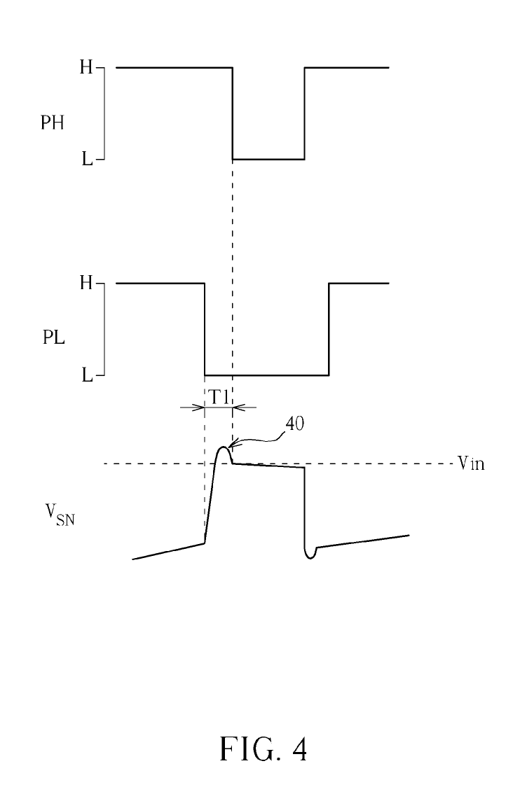

Please refer to FIG. 3. If the voltage of voltage source 332, i.e. the crossing voltage, is set not to be negative enough, that is, the crossing voltage is negative but too close to 0 volt, then the low-side switch SL may be turned off late so that the reverse current still occurs. Please refer to FIG. 4. When the time goes to a dead time T1 after low-side switch SL is turned off and before high-side switch SH is turned on, a possible reverse current may flow from output terminal Q to connection node SN via inductor L. This reverse current may then flow through the body diode of high-side switch SH and then to power line Vᵢₙ. As can be inducted, this reverse current will result in the potential V_{SN} at connection node SN being abruptly higher than the voltage of power line Vᵢₙ, forming the bump denoted by a label 40 shown in FIG. 4.

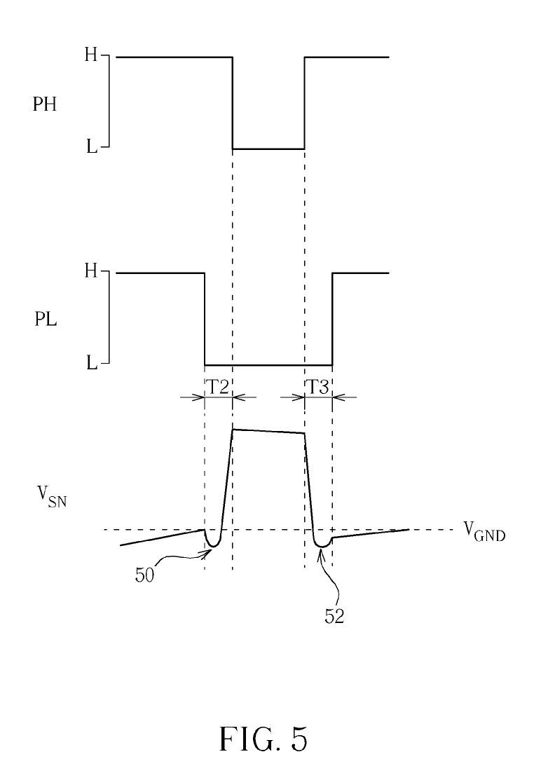

If the value of voltage 332 is set to be too low, that is, if the crossing voltage is so far away from 0 volt, then, during a dead time T2 (shown in FIG. 5) after the low-side switch SL is turned off and before the high-side switch SH is turned on, a residual positive current may be introduced and flow from connection node SN to output terminal Qvia inductor L. This positive current may flow from power line GND to connection node SN via the body diode of low-side switch SL. At this time, the positive current results in the potential V_{SN} at the connection node SN being lower than the ground voltage V_{GND}, forming the notch denoted by a label 50 shown in FIG. 5.

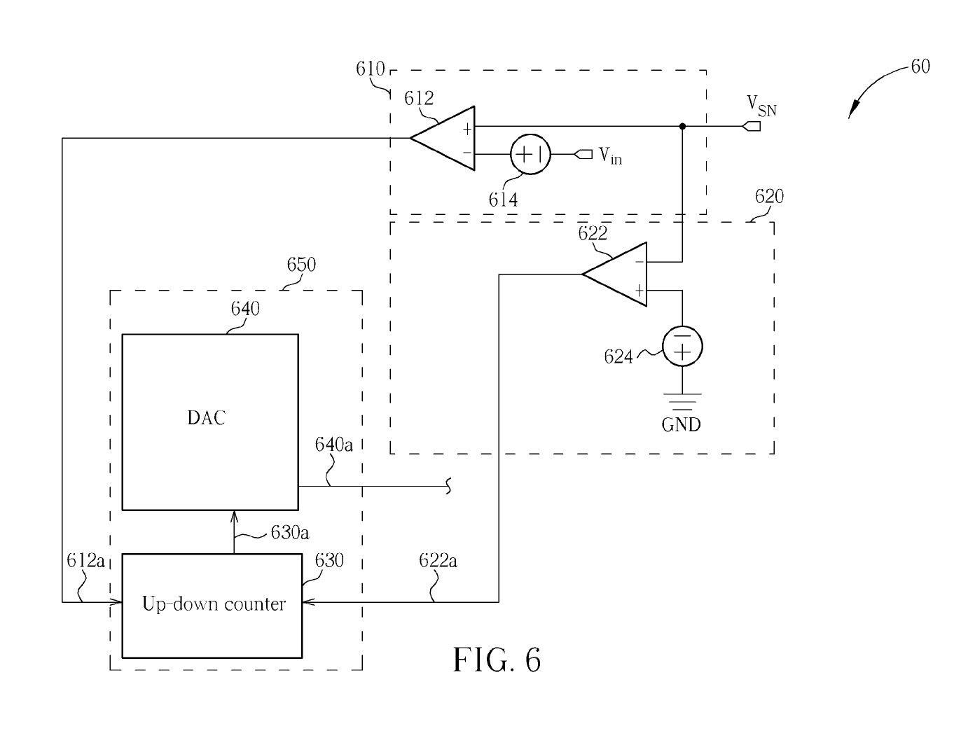

FIG. 6 is a circuit diagram of a circuit 60 for preventing a reverse current according to one preferred embodiment of the present invention. Circuit 60 includes detection module 610, detection module 620, and a threshold voltage adjusting module 650 including an up-down counter 630 and a digital-to-analog converter (DAC) 640. Within a dead time, if detection module 610 detects a reverse current, or if detection module 620 detects a positive current, the threshold voltage adjusting module may be utilized to adjust the crossing voltage output from node 640a, in order to adjust the duration of turn-on time of low-side switch SL.

As shown by FIG. 6, detection module 610 includes a comparator 612 and reference voltage source 61 4. An inverting terminal of comparator 612 is coupled to one terminal of reference voltage source 614, which has another terminal coupled to power line Vᵢₙ. In this embodiment, the value of reference voltage source 614 is designed to be less than the forward bias voltage of the body diode in high-side switch SH. In other words, comparator 612 compares voltage V_{SN} with a reference voltage, which is higher than the voltage level of power line V_{IN} but less than the summation of the voltage level of power line V_{IN} and the forward bias voltage of the body diode in high-side switch SH.

As illustrated in FIG. 4, when a reverse current is introduced during the dead time T1, it can be expected that voltage V_{SN} at connection node SN is higher than the reference voltage resulted by both power line Vᵢₙ and reference voltage source 614, such that comparator 612 may transit its output signal 612a to trigger the up-down counter 630 and to increase its output number by a first predetermined value. The output signal 630a counted and output by up-down counter 630 is converted by the DAC 640 to analog output signal 640a, which may be taken as the output of the voltage source 332 shown in FIG. 3. According to this design, the output of voltage source 332, i.e. the crossing voltage, may be getting lower, that is, the voltage 332 may be farther away from 0 volt. Accordingly, in a subsequent switching cycle, low-side switch SL can be turned off earlier to avoid the occurrence of the reverse current.

Similar with detection module 610, detection module 620 in FIG. 6 includes comparator 622 and reference voltage source 624, which has one terminal coupled to power line GND. Please note that power line GND is also coupled to low-side switch SL. The voltage value of reference voltage source 614 is designed to be lower than the forward bias voltage of the body diode in low-side switch SL. In other words, comparator 622 compares voltage V_{SN} with a reference voltage, which is negative but higher than minus the forward bias voltage of the body diode in low-side switch SL.

Referring to FIG. 5, when a residual positive current occurs during dead time T2, voltage V_{SN} at the connection node SN is expected to be lower than the reference voltage resulted by both power line GND and reference voltage source 624, such that comparator 622 will transit to trigger the up-down counter 630 to decrease its output number by another predetermined value. By this way, the output voltage of voltage source 332, i.e. the crossing voltage, will become higher and closer to 0 volt. In a subsequent switch cycle, the low-side switch SL can be turned off later to reduce the residual positive current.

Besides, as shown in FIG. 5, there is another dead time dead time T3 after high-side switch SH is turned off and before low-side switch SL is turned on. Since switches SL and SH are both turned off and a positive current can be constantly expected during this dead time T3, there will be a notch 52 occurring as shown in FIG. 5. It is not what is targeted in the present embodiment, and therefore detection module 620 should be designed to ignore notch 52 during dead time T3, but take notch 50 during dead time T2 into consideration.

With the aid of both detection modules 610 and 620 of the present embodiment, the up-down counter 630 may correspondingly increase its output number by a predetermined value or decrease by another predetermined value. These two predetermined values can be or can be not the same, and the choice is up to the designer.

In one embodiment, the detection of the reverse or positive current immediately alters the crossing voltage. In other embodiments, one time of the detection of the reverse or positive current does not result in the change of the crossing voltage, but many times of the detection may do. For example, in one embodiment, the output of up-down counter 630 is altered to change the crossing voltage when detection module 610 successively detects the reverse current predetermined times. Therefore, an occasionally-occurring reverse current can be ignored. Similarly, the output of up-down counter 630 may be altered when detection module 620 successively detects the positive current predetermined times.

In sum, the steps of the corresponding method for preventing a reverse current are abstracted as follows:

(a) detecting if a reverse current flows from output terminal Q to connection node SN via inductor L within a dead time;

(b) detecting within the dead time if a positive current flows from connection node SN to output terminal Qvia inductor L; and

(c) adjusting a subsequent turn-on on of the second switch SL when the reverse current or the positive current is detected.

The present invention is not limited to the aforementioned embodiments in detecting the existence of the reverse current or the residual positive current within the dead time to adjust the turn-on time of low-side switch SL. It indicates that embodiments of the present invention may apply other methods for detecting the existence of the reverse current or the residual positive current within a dead time to adjust the turn-on time of low-side switch SL.

Besides, the elements included in circuit 60 for preventing the reverse current merely indicate a preferred embodiment of the present invention. Moreover, replacement of each element in circuit 60 to achieve similar effect is obvious to those skilled in the art. Therefore, it is not beyond the scope of the present invention to replace any element of the circuit 60.

Those skilled in the art will readily observe that numerous modifications and alterations of the device and method may be made while retaining the teachings of the invention.

What is claimed is:

1. A circuit for preventing a reverse current, the circuit being applicable to a voltage converter including a first switch, a second switch, and an inductor, wherein the first and second switches are coupled in series between two power lines; and the inductor is coupled between an output terminal of the voltage converter and a connection node connecting the first and second switches, wherein the reverse current flows from the output terminal to the connection node; the circuit comprising:
a first detection module, for detecting whether a reverse current occurs within a dead time when the first and second switches are both off; and
a threshold voltage adjusting module, for adjusting a crossing voltage according to the detection of the reverse current, wherein the second switch is turned off when the voltage of the connection node exceeds the crossing voltage.

2. The circuit of claim 1, wherein the first switch is coupled to a relatively-high voltage power line, the second switch is coupled to a relatively-low voltage power line, and the first detection module detects if the reverse current flows via the first switch.

3. The circuit of claim 1, further comprising a second detection module, for detecting whether a positive current occurs and flows from the connection node to the output terminal via the inductor within the dead time.

4. The circuit of claim 3, wherein the first switch is coupled to a relatively-high voltage power line, the second switch is coupled to a relatively-low voltage power line, the second detection module is for detecting if the positive current flows via the second switch, and the dead time is ranged within a duration after the second switch is turned off and before the first switch is turned on.

5. The circuit of claim 3, wherein the threshold voltage adjusting module comprises a counter; and, when the positive current is detected, the output value of the counter varies to adjust the crossing voltage.

6. The circuit of claim 5, wherein the threshold voltage adjusting module further comprises a digital-to-analog converter (DAC) for generating the crossing voltage according to the output value of the counter.

7. The circuit of claim 3, wherein the second detection module comprises a comparator comparing the voltage of the connection node with a reference voltage; and the positive current is detected when the voltage of the connection node is less than the reference voltage.

8. The circuit of claim 7, wherein the reference voltage is higher than a ground voltage minus a forward bias voltage of a body diode in the second switch.

9. The circuit of claim 1, wherein the threshold voltage adjusting module comprises a counter; and, when the reverse current is detected, the output value of the counter varies to adjust the crossing voltage.

10. The circuit of claim 9, wherein the threshold voltage adjusting module further comprises a digital-to-analog converter (DAC) for generating the crossing voltage according to the output value of the counter.

11. The circuit of claim 1, wherein the first detection module comprises a comparator comparing the voltage of the connection node with a reference voltage; and the reverse current is detected when the voltage of the connection node exceeds the reference voltage.

12. The circuit of claim 11, wherein the reference voltage is less than the summation of the voltage level of a relative-high voltage power line and a forward bias voltage of a body diode in the first switch.

13. A method for preventing a reverse current, the method being applicable to a voltage converter including a high-side switch, a low-side switch, and an inductor; wherein the high-side and low-side switches are coupled in series between a relatively-high power line and a relatively-low power line; and the inductor is coupled between an output terminal of the voltage converter and a connection node connecting between the high-side and low-side switches, wherein the reverse current flows from the output terminal to the connection node, the method comprising:
detecting if a reverse current occurs during a dead time when the high-side and low-side switches are both off; and
shortening a subsequent turned-on duration of the low-side switch when the reverse current is detected.

14. The method of claim 13, wherein the low-side switch is turned off when the voltage of the connection node exceeds a crossing voltage; and shortening the subsequent turned-on duration of the low-side switch comprises adjusting the crossing voltage when the reverse current is detected.

15. The method of claim 13, further comprising:
detecting if a positive current occurs and flows from the connection node to the output terminal via the inductor within the dead time; and
elongating a subsequent turned-on duration of the low-side switch when the positive current is detected.

16. The method of claim 15, wherein the low-side switch is turned off when the voltage of the connection node exceeds a crossing voltage; and elongating the subsequent turned-on duration of the low-side switch comprises adjusting the crossing voltage when the positive current is detected.

17. The method of claim 13, wherein the dead time is within a duration after the low-side switch is turned off and before the high switch is turned on.

18. A method for adjusting a crossing voltage to prevent the occurrence of a reverse current, applicable to a voltage converter including a high-side switch, a low-side switch and a inductor, wherein the high-side and low-side switches are coupled to the inductor through a connection node, and the reverse current flows from the inductor to the connection node, the method comprising:
turning off the low-side switch when the voltage of the connection node exceeds the crossing voltage; detecting the voltage of the connection node to determine if the reverse current occurs during a dead time when both the low-side and high-side switches are off; and decreasing the crossing voltage when the reverse current is detected during the dead time.

19. The method of claim 18, wherein the dead time is within a duration after the low-side switch is turned off and before the high switch is turned on.

20. The method of claim 18, wherein a positive current flows to the inductor from the connection node, and the method comprises:
detecting the voltage of the connection node to determine if the positive current occurs during the dead time; and increasing the crossing voltage when the positive current is detected during the dead time.
